(19) United States
(12) Patent Application Publication
(10) Pub. No.: US 2021/0079492 A1
(43) Pub. Date: Mar. 18, 2021

(54) METHOD OF MANUFACTURING COMPONENTS OF AN AUTOMOTIVE VEHICLE FRAME

(71) Applicants: Bryan J Macek, Auburn Hills, MI (US); Jose L Galaviz, Rochester Hills, MI (US); Jean-Damien C Bertrand, Rochester Hills, MI (US); Randy T Gerken, White Lake, MI (US)

(72) Inventors: Bryan J Macek, Auburn Hills, MI (US); Jose L Galaviz, Rochester Hills, MI (US); Jean-Damien C Bertrand, Rochester Hills, MI (US); Randy T Gerken, White Lake, MI (US)

(21) Appl. No.: 16/572,791

(22) Filed: Sep. 17, 2019

(51) Int. Cl. C21D 9/50; C21D 1/673; B23K 11/11; B21D 53/88

(52) U.S. Cl. CPC C21D 9/50; C21D 1/673; C21D 2211/001; B21D 53/88; B23K 11/11

(57) ABSTRACT

A method of manufacturing a component of an automotive vehicle frame comprises welding a reinforcement element to a blank comprised of ultra high strength steel and then heating in a furnace the blank and reinforcement element to at least a predetermined temperature. Once the blank and reinforcement element are heated to at least the predetermined temperature, the method comprises transferring the heated blank to a forming tool, forming with the forming tool the blank and reinforcement element into a desired shape for the vehicle frame component, and cooling or allowing the formed component to cool until it reaches a predetermined state.

### FIELD

The present disclosure relates to methods of manufacturing components of an automotive vehicle frame, for example, components of a frame for a body-on-frame vehicle.

### BACKGROUND

Many automotive vehicles include a frame that provides a structure to which various vehicle components can be mounted. For a variety of reasons, at least certain portions of that frame may require high levels of strength and/or stiffness. As such, the frame, or at least certain components thereof, may be formed of a high strength material, such as, for example, Advanced High Strength Steel (AHSS). Frame components formed of AHSS are typically manufactured using a cold forming process and then portions of the frame component requiring additional strength and/or stiffness may be reinforced by arc welding one or more separately-manufactured reinforcement elements to the cold-formed body of the component at the appropriate location(s).

Components formed of AHSS add a significant amount of weight to the vehicle. Additionally, local reinforcement of portions of the frame component require the separate production of reinforcements that have to be welded to the already-formed frame body of the frame component, resulting in, for example, additional cost and complexity to the manufacturing process. Further, the cold forming process used to manufacture frame components out of AHSS typically has larger than desired geometric tolerances presenting additional manufacturing difficulties.

### SUMMARY

In at least some implementations, a method of manufacturing a component of an automotive vehicle frame comprises heating a blank comprised of ultra high strength steel to at least a predetermined temperature, forming with a forming tool the heated blank into a desired shape for the vehicle frame component, and then cooling or allowing the formed component to cool until it reaches a predetermined state.

In at least some implementations, a method of manufacturing a component of an automotive vehicle frame comprises welding a reinforcement element to a blank comprised of ultra high strength steel and then heating the blank and reinforcement element to at least a predetermined temperature. Once the blank and reinforcement element are heated to at least the predetermined temperature, the method comprises transferring the heated blank and reinforcement element to a forming tool, forming with the forming tool the blank and reinforcement element into a desired shape for the vehicle frame component, and then cooling or allowing the formed component to cool until it reaches a predetermined state.

In at least some implementations, a component of an automotive vehicle frame comprises a body formed of ultra high strength steel and a reinforcement element, wherein when the component is formed, the body and the reinforcement element are of a unitary construction. The component further includes a first portion comprising a first portion of the body and having a first thickness and a second portion comprising a second portion of the body and the reinforcement element and having a second thickness greater than the first thickness.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a flow diagram depicting various steps of an illustrative embodiment of a method of manufacturing a component of an automotive vehicle frame;

FIG. 2 is a diagrammatic view of a blank and a reinforcement element that may be joined together during the performance of the method illustrated in FIG. 1;

FIG. 3 is a diagrammatic view of the blank and reinforcement element depicted in FIG. 2 joined together; and

FIG. 4 is a diagrammatic view of a component of a vehicle frame formed from the blank and reinforcement element and manufactured using the method illustrated in FIG. 1.

### DETAILED DESCRIPTION

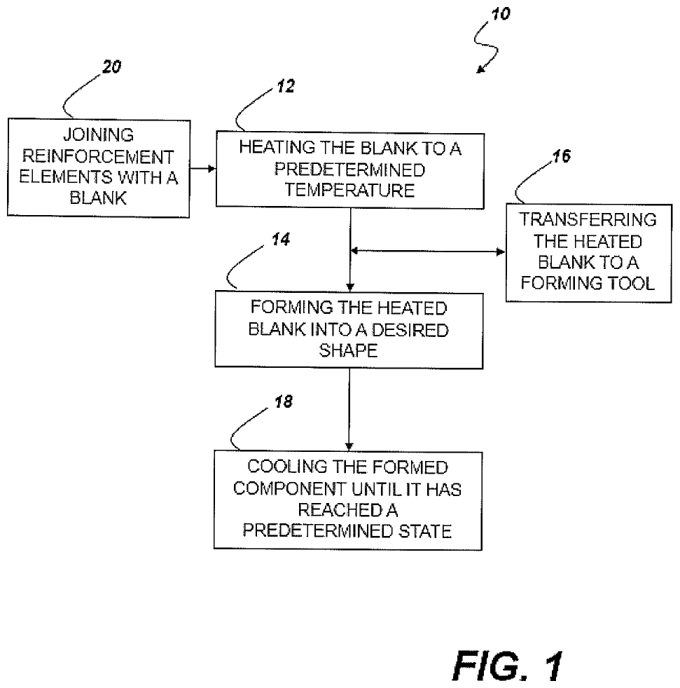

Referring in more detail to the drawings, FIG. 1 illustrates a method 10 of manufacturing a component of an automotive vehicle frame, for example and without limitation, a rail or beam or cross-member of a vehicle frame. The method 10 comprises a hot forming process for manufacturing an automotive vehicle frame component of ultra high strength steel (UHSS). The method 10 may find application with a number of different types of UHSS, including, for example and without limitation, 22MnB5 (DIN ENISO 683-2) steel and 15B21 (SAE J1268) steel. But typically, any steel having the following mechanical properties would be suitable: a tensile strength of 550-1500 MPa; a total elongation of 5-15% after forming (as measured by ASTM E8, ISO 6892-1, or similar specification); and a Youngs modulus of 205-210 GPa. Accordingly, the present disclosure is not intended to be limited to any particular type(s) of UHSS steel.

The method 10 is a departure from conventional vehicle frame component manufacturing processes that utilize cold forming processes to manufacture frame components out of advanced high strength steel (AHSS), and that require post-formation reinforcement of portions of the component by arc welding one or more separately-manufactured reinforcement elements to that or those portions of the body of the component.

As shown in FIG. 1, the method includes a step 12 of heating a blank comprised of UHSS to at least a predetermined temperature. The heating of the blank increases the ductility of the blank and reduces its hardness so that it can be more easily formed in a later step of method 10. In an embodiment, the predetermined temperature is the austenitic transformation temperature of the particular UHSS being used (i.e., the temperature at which recrystallization of the UHSS material occurs). The particular value of this predetermined temperature, however, may be dependent upon a number of factors including, for example, the particular type of UHSS that is being used, for example, the types of UHSS described above. Accordingly, it will be appreciated that the predetermined temperature is an empirically-derived temperature value that is determined prior to the performance of method 10 and that is dependent upon the particular material being used. For purposes of illustration, however, in at least some embodiments the predetermined temperature may be in the range of 800-950° C. By way of example, the austenitic transformation for 22MnB5 steel occurs at approximately 834° C.

In addition to the above, step 12 may also include heating the blank at the predetermined temperature for a predetermined period of time to ensure the austenitization of the blank. As with the predetermined temperature, the particular value of this predetermined period of time may be dependent upon a number of factors including, for example, the particular type of UHSS that is being used. Accordingly, it will be appreciated that the predetermined period of time is an empirically-derived value that is determined prior to the performance of method 10 and that is dependent upon the particular material being used. By way of example, however, for at least certain types of steel (e.g., 22MnB5 steel) the predetermined period of time is typically between 4-10 minutes.

Step 12 may be performed in a number of ways. One way is by placing the blank into a suitable heating device, for example, an oven or furnace, that is configured to heat blanks formed of UHSS to the required predetermined temperature or temperature range. It will be appreciated, however, that any suitable means for heating UHSS blanks to at least a predetermined temperature may be used, and thus, the present disclosure is not limited to any particular way(s) of performing step 12.

Following step 12, the method 10 may proceed to a step 14 of forming the heated blank into a desired shape for the vehicle frame component being manufactured. More specifically, a forming tool, such as, for example, a die of a press machine may be used to form the heated blank into the desired shape. In an embodiment, step 14 is performed while the blank is in the austenitic condition and may be performed while the heated blank is still in the oven or furnace or, alternatively, after it has been removed from the oven or furnace.

In an instance where the heated blank is formed while in the oven or furnace, the blank may be loaded onto a die of a press either before or after the heating process, and then after the blank is heated to at least the desired predetermined temperature, the press may be operated to form the heated blank into the desired shape.

On the other hand, in an instance where the heated blank is formed after it has been removed from the oven or furnace, the method 10 may include one or more additional steps prior to the forming step 14. For example, and as illustrated in FIG. 1, the method 10 may include a step 16 of transferring the heated blank to a die of a press. This transfer may be effectuated using any number of techniques known in the art, for example and without limitation, using a material handling gantry or a robot end effector. In an embodiment, the die to which the heated blank is transferred is maintained at room temperature. In such an embodiment, the die may comprise a cooled die, for example, a water-cooled die. In other embodiments, however, the die may be cooled other than by water, and thus, the present disclosure is not intended to be limited to any particular type of cooled die. In any event, as with the embodiment described above, one the heated blank has been transferred to the die, the press is operated to form the heated blank into the desired shape for the frame component being manufactured.

Once the heated blank has been formed into the desired shape for the frame component being manufactured, the method 10 may proceed to a step 18 of cooling the formed component until it has reached a predetermined state. In an embodiment, the predetermined state corresponds to the completion of the phase transformation of the material that began when the blank was heated in step 12. Completion of the phase transformation can be determined by detecting or determining that the temperature of the formed component has reached or fallen below a predetermined temperature. In an embodiment, this temperature is the Martensite Finish temperature for the particular material being formed. In other embodiments, the predetermined temperature is a temperature value at least a certain amount below the Martensite Finish temperature, for example, 100-200° C. below the Martensite Finish temperature. As with the predetermined temperature discussed with respect to step 12, the particular value of the predetermined temperature used to determine the completion of the phase transformation process in step 18 may be dependent upon a number of factors including, for example, the particular type of UHSS that is being used. Accordingly, it will be appreciated that the predetermined temperature is an empirically-derived temperature value that is determined prior to the performance of method 10 and that is dependent upon the particular material being used. For purposes of illustration, however, in an embodiment when 22MnB5 steel is used, the predetermined temperature may be in the range of 635-735° C.

In any event, the formed component may be cooled in a number of ways. In an instance where a cooled die is used in the forming step 14, the component may be held in the die and the die may contribute to the cooling of the component. In other embodiments, however, alternative or additional external cooling means may be used to cool the component. Regardless of the particular way in which the component is cooled, the component may be cooled at particular rate that may be dependent upon one or more factors such as, for example, the particular material being used to form the component. For purposes of illustration, however, in at least some embodiments the rate may be on the order of 25-100° C./s, and in at least one embodiment, at approximately 25-30° C./s (e.g., 27° C./s).

Depending on the particular component being manufactured, portions of the component may require greater strength and/or stiffness than other portions of the component. To account for this, rather than forming the entirety of the component to meet these increased strength and/or stiffness requirements or targets (and thereby using an unnecessary amount of material that adds costs and weight to the vehicle), local reinforcements may be used to increase the strength and/or stiffness of the relevant portion(s) of the component. In an embodiment wherein reinforcement is needed, the method 10 may include one or more steps performed prior to the heating step 12, forming step 14, and/or cooling step 18.

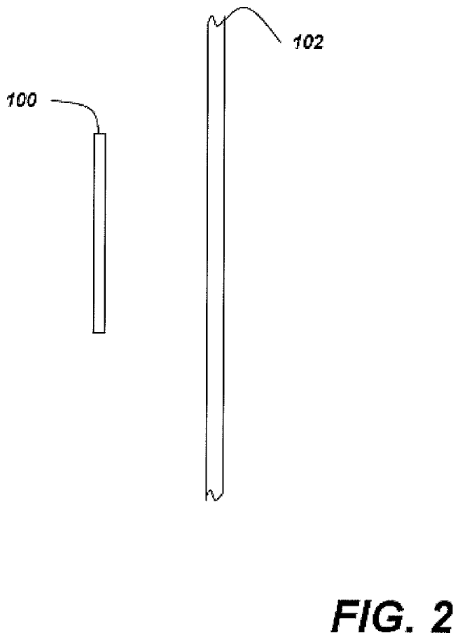

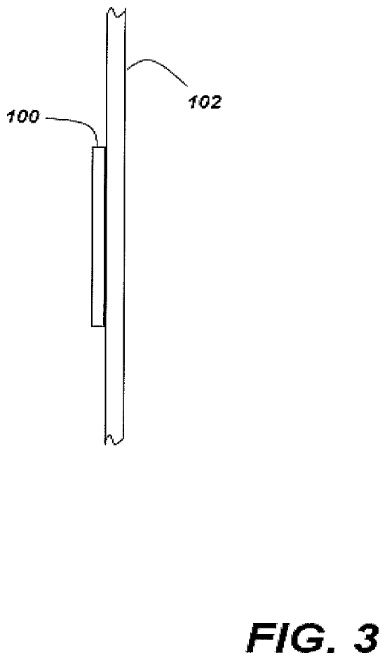

More particularly, and as shown in FIG. 1 and with reference to FIGS. 2 and 3, in an embodiment the method 10 may include a step 20 of joining one or more reinforcement elements (reference numeral 100 in FIG. 2) with the blank (reference numeral 102 in FIGS. 2 and 3) at a location on the blank corresponding to a location on the vehicle frame component requiring reinforcement. The reinforcement element may be formed or made from the same material as the blank or may be a different material that is suitable for reinforcing a component from of the blank material. And any number of suitable techniques for joining a reinforcement element with the blank may be used in step 20, including, but not limited to, one or more welding techniques (e.g., resistance spot welding, arc welding, laser welding techniques, or any other suitable welding technique). Regardless of the particular technique that is used, once the one or more reinforcement elements are joined with the blank, the method 10 may proceed to step 12 where the combination of the blank and the reinforcement element(s) are heated to at least the predetermined temperature, and then to step 14 where the combination of the heated blank and reinforcement element(s) are formed into a desired shape.

Joining the reinforcement element(s) with the blank prior to the heating and forming steps provides a number of advantages over the reinforcement techniques utilized for vehicle frame components manufactured from AHSS using conventional cold forming processes. More specifically, in conventional cold-forming manufacturing processes, separate reinforcement elements have to be produced and then arc welded onto the formed body of the component after the completion of the cold forming process. Not only does this increase the cost and complexity of the manufacturing process, but the arc welds create heat affected zones (HAZ) that must be considered when designing for strength and/or durability.

By joining the reinforcement elements to the blank prior to the heating and forming steps of the method 10, the welds between the reinforcement element and the blank are annealed and hardened during the heating, forming, and cooling steps of the method 10 thereby eliminating, or at least mitigating, the formation of HAZ and negative effects on material properties. Improved geometric tolerances provided using the hot forming methodology described above also allow greater control over weld gaps, simplifying assembly of the component with other components of the vehicle frame. Additionally, a wider range of thickness ratios between the non-reinforced and reinforced portions of the component are possible using the above-described methodology because relatively thin reinforcement elements can be joined to the blank (e.g., thickness ratio of 1:2 or less), which is difficult to do using the conventional cold forming process and post-formation reinforcement technique since relatively thin reinforcement elements cannot be reliably arc welded to thicker materials.

The method 10 described above may be used to manufacture any number of vehicle frame components, such as, for example and without limitation, rails or beams or cross members or kick-up/kick-down assemblies. And because the methodology can be performed using UHSS which is stronger, lighter, and has a greater formability than AHSS, stronger components that have a smaller mass and, in some instances, relatively small radii and tight tolerances can be manufactured using the method 10.

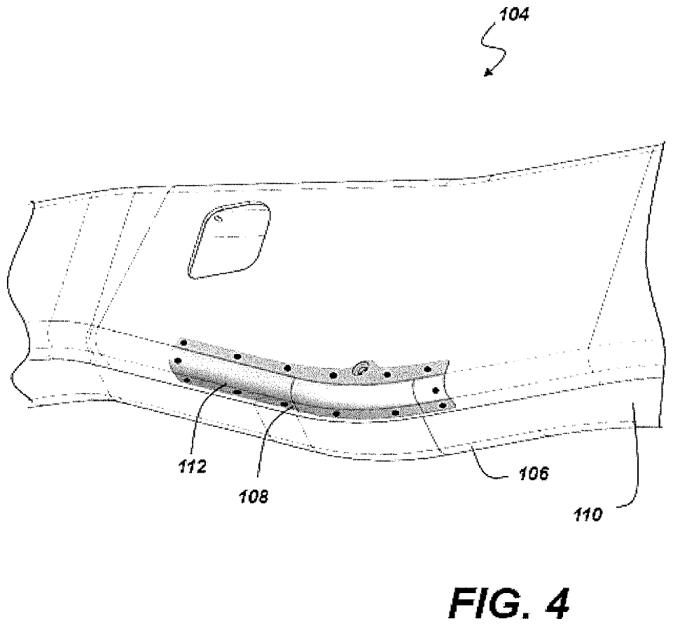

For purposes of illustration, FIG. 4 depicts an example of a formed component 104 that is manufactured using the method 10 described above. The component 104 may comprise a body 106 formed of UHSS and a reinforcement element 108, wherein after the heating and forming steps of method 10, the body 106 and the reinforcement element 108 are of a unitary construction. The reinforcement element 108 may be formed of any type of material suitable for hot forming, including, for example and without limitation, one or more of those materials identified elsewhere above. The component 104 further includes a first portion 110 that comprises a first portion of the body 106 and has a first thickness, and a second portion 112 that comprises a second portion of the body and the reinforcement element, and that has a second thickness that is greater than the first thickness due to the inclusion of the reinforcement element. For example, in an embodiment, the ratio between the first thickness and second thickness may be 3:1; though other ratios are certainly possible.

What is claimed is:

1. A method of manufacturing a component of an automotive vehicle frame, comprising:
heating a blank comprised of ultra high strength steel to at least a predetermined temperature;
forming with a forming tool the heated blank into a desired shape for the vehicle frame component; and
cooling or allowing the formed component to cool until it reaches a predetermined state.

2. The method of claim 1, wherein prior to the heating step, the method comprises welding a reinforcement element to the blank at a location on the blank corresponding to a location on the vehicle frame component requiring reinforcement, and wherein the heating step comprises heating the combination of the blank and the reinforcement element welded to the blank.

3. The method of claim 2, wherein the welding step comprises resistance spot welding the reinforcement element to the blank.

4. The method of claim 2, wherein the welding step comprises arc welding the reinforcement element to the blank.

5. The method of claim 1, wherein the predetermined temperature comprises the austenitic transformation temperature of the ultra high strength steel.

6. The method of claim 1, wherein the vehicle frame component comprises a component of a frame for a body-on-frame vehicle.

7. The method of claim 1, wherein following the heating step, the method further comprises transferring the heated blank to the forming tool.

8. The method of claim 7, wherein the forming tool comprises a cooled forming tool.

9. The method of claim 8, wherein the cooling step comprises cooling the formed component in the cooled forming tool.

10. The method of claim 1, wherein the forming step comprises forming the heated blank into the desired shape while the blank is in an austenitic condition.

11. A method of manufacturing a component of an automotive vehicle frame, comprising:
welding a reinforcement element to a blank comprised of ultra high strength steel;
heating the blank and the reinforcement element to at least a predetermined temperature;
once the blank and reinforcement element are heated to at least the predetermined temperature, transferring the heated blank to a forming tool;
forming with the forming tool the combination of the blank and reinforcement element into a desired shape for the vehicle frame component; and
cooling or allowing the formed component to cool until it reaches a predetermined state.

12. The method of claim 11, wherein the welding step comprises resistance spot welding the reinforcement element to the blank.

13. The method of claim 11, wherein the welding step comprises arc welding the reinforcement element to the blank.

14. The method of claim 11, wherein the vehicle frame component comprises a component of a frame for a body-on-frame vehicle.

15. The method of claim 11, wherein the forming tool comprises a cooled forming tool.

16. The method of claim 15, wherein the cooling step comprises cooling the formed component in the cooled forming tool.

17. The method of claim 11, wherein the predetermined temperature comprises the austenitic transformation temperature of the ultra high strength steel.

18. The method of claim 11, wherein the forming step comprises forming the heated blank into the desired shape while the blank is in an austenitic condition.

19. A component of an automotive vehicle frame comprising:
a body formed of ultra high strength steel; and
a reinforcement element, wherein when the component is formed, the body and the reinforcement element are of a unitary construction,
wherein a first portion of the component comprises a first portion of the body and has a first thickness; and
a second portion of the component comprises a second portion of the body and the reinforcement element and has a second thickness that is greater than the first thickness.
